(19) United States
(12) Patent Application Publication
(10) Pub. No.: US 2014/0032395 A1
(43) Pub. Date: Jan. 30, 2014

(54) SYSTEM AND METHOD FOR GRANTING A TEMPORARY OVERDRAFT AUTOMATICALLY

(71) Applicant: Kaniyanoor Seshadri Rajasekaran, Bangalore (IN)

(72) Inventor: Kaniyanoor Seshadri Rajasekaran, Bangalore (IN)

(73) Assignee: INFOSYS LIMITED, Bangalore (IN)

(21) Appl. No.: 14/110,360

(22) PCT Filed: Dec. 26, 2011
(86) PCT No.: PCT/IN2011/000892

§ 371 Date: Oct. 7, 2013

(30) Foreign Application Priority Data
Apr. 7, 2011 (IN) 1207/CHE/2011

(51) Int. Cl. G06Q 40/02

(52) U.S. Cl. CPC G06Q 40/025
USPC 705/38

(57) ABSTRACT

A system and a computer implemented method for granting a temporary overdraft automatically are described. In an example embodiment, one or more parameters are associated with a bank account and stored in a computer readable storage medium, the storage medium in operable communication with a processor. On receiving a payment request, the one or more parameters are retrieved and a temporary overdraft is granted to the bank account, wherein an interest rate associated with the temporary overdraft is determined on the basis of the one or more parameters. Further aspects of the system and method described include the linkage of collateral to the bank account, whereby a maximum credit limit for an associated secured temporary overdraft is determined. In an additional aspect, an unsecured temporary overdraft is authorized, contingent on the present value of linked collateral.

### BACKGROUND

The invention relates generally to the field of financial transactions, and, more particularly, to the use of temporary overdrafts in a financial transaction. Specifically, the invention relates to a system and method for granting a temporary overdraft to a bank account automatically.

The practice of granting an overdraft is well known. Such are generally granted by a bank when an account-holder seeks to withdraw money, from her bank account, that exceeds the amount deposited. Along these lines, a temporary overdraft may be defined as a short term, temporally limited, overdraft granted to an account holder. In current practice, a key step in the grant of temporary overdrafts is the imposition of an overdraft limit, the overdraft limit linked to a particular bank account. As an example, when a temporary overdraft facility is applied for by a customer, a suitable credit limit related to the temporary overdraft is assessed on the basis of certain norms, including, for example, the customer's credit worthiness. The overdraft is then granted accordingly.

Additionally, in current practice, an overdraft may either be issued for an amount for which it is applied, or incurred as a result of an overdrawing financial transaction. Such a broad based rule, practically applied, may result in a circumstance wherein banks lack the facility to implement a temporary overdraft triggering mechanism that is based exclusively on specific events. For example, an account holder may not wish to apply in advance for a fixed overdraft facility, but is committed to honoring all checks, and checks only, that are drawn against her account. In such an instance, the account-holder would ordinarily be reduced to estimating a nominal upper limit for a temporary overdraft that may be incurred, and may, additionally, lack the ability to restrict the incurrence of the overdraft to a specific payment instrument. Deprived of the flexibility to define specific criteria upon which a temporary overdraft may be triggered automatically, the account-holder may thus be compelled to carry an overdraft for longer than she would prefer, or for the wrong reasons.

Accordingly, there is a need for a greater flexibility in the authorization of temporary overdrafts by a financial institution. Flexibility in both the evaluation of an account-holder's credit limit related to a temporary overdraft, and in the payment mechanism by which it may be triggered is desired.

### SUMMARY OF THE INVENTION

A system and method for granting a temporary overdraft are provided.

In an aspect of a present implementation, a system for granting a temporary overdraft for a bank account automatically is described. The system may comprise a processor readable storage medium in communication with a processor, and the processor readable storage medium may contain one or more programming instructions for associating at least one parameter with the bank account. These instructions may include storing the at least one parameter associated with the bank account in the processor readable storage medium, receiving a payment request from a payment instrument associated with the bank account wherein the payment request exceeds a bank balance associated with the bank account, and granting a temporary overdraft, wherein the temporary overdraft is linked to the bank account and an interest rate associated with the temporary overdraft is determined on the basis of at least one parameter associated with the bank account.

In a further aspect, a computer implemented method for granting a temporary overdraft is described. As described, the computer implemented method may comprise associating at least one parameter with a bank account, storing the at least one parameter associated with the bank account in a computer readable storage medium, receiving a payment request from a payment instrument associated with the bank account wherein the payment request exceeds a bank balance associated with the bank account. The method may further include authorizing a temporary overdraft for the bank account wherein the temporary overdraft is linked to the bank account, retrieving the at least one parameter from the computer readable storage medium and determining an interest rate for the temporary overdraft on the basis of the at least one parameter associated with the bank account.

Further features, including the structure and operation of various embodiments, are described in the detailed description below. Such embodiments are to be understood in light of said detailed description in conjunction with the accompanying drawings to which it may refer.

### DRAWINGS

These and other features, aspects, and advantages of the present invention will be better understood when the following detailed description is read with reference to the accompanying drawings in which like characters represent like parts throughout the drawings, wherein:

FIG. 1 is a block diagram illustrating a method of granting an overdraft automatically, in accordance with a presented embodiment.

FIG. 2 is an illustration of an interaction of a computing environment with a payment instrument, in accordance with a presented embodiment.

FIG. 3 is an illustration of the computing environment involved in the grant of a temporary overdraft.

FIG. 4 is a depiction of an example implementation, wherein parameters related to a temporary overdraft are defined.

### DETAILED DESCRIPTION

The following description is the full and informative description of the best method and system presently contemplated for carrying out the present invention which is known to the inventors at the time of filing the patent application. Many modifications and adaptations may be apparent to those skilled in the relevant arts in view of the following description and further in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

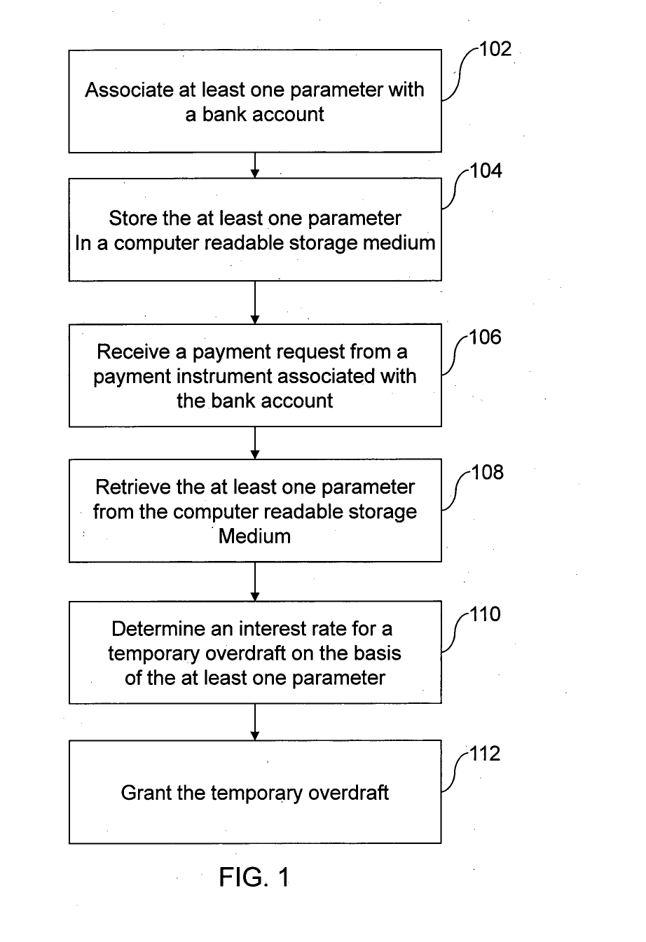

Referring to FIG. 1, an embodiment of a computer implemented method for granting a temporary overdraft automatically is depicted. As depicted in a block 102, the method may include associating at least one parameter with a bank account. Further, as in a block 104, each of the parameters is stored in a computer readable storage medium. In a further block, 106, a payment request from a payment instrument associated with the bank account is received. On reception of the payment request, the one or more parameters associated with the bank account are retrieved, as in a block 108, and an interest rate for the temporary overdraft determined on that basis, as in a block 110. The temporary overdraft is then authorized accordingly, as in a block 112.

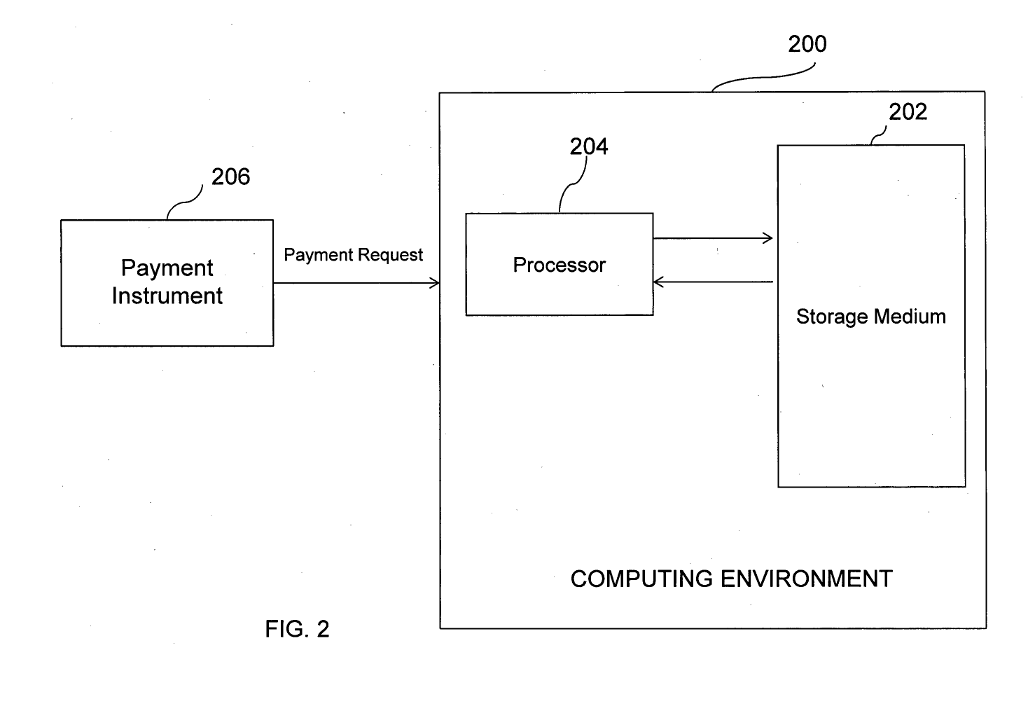

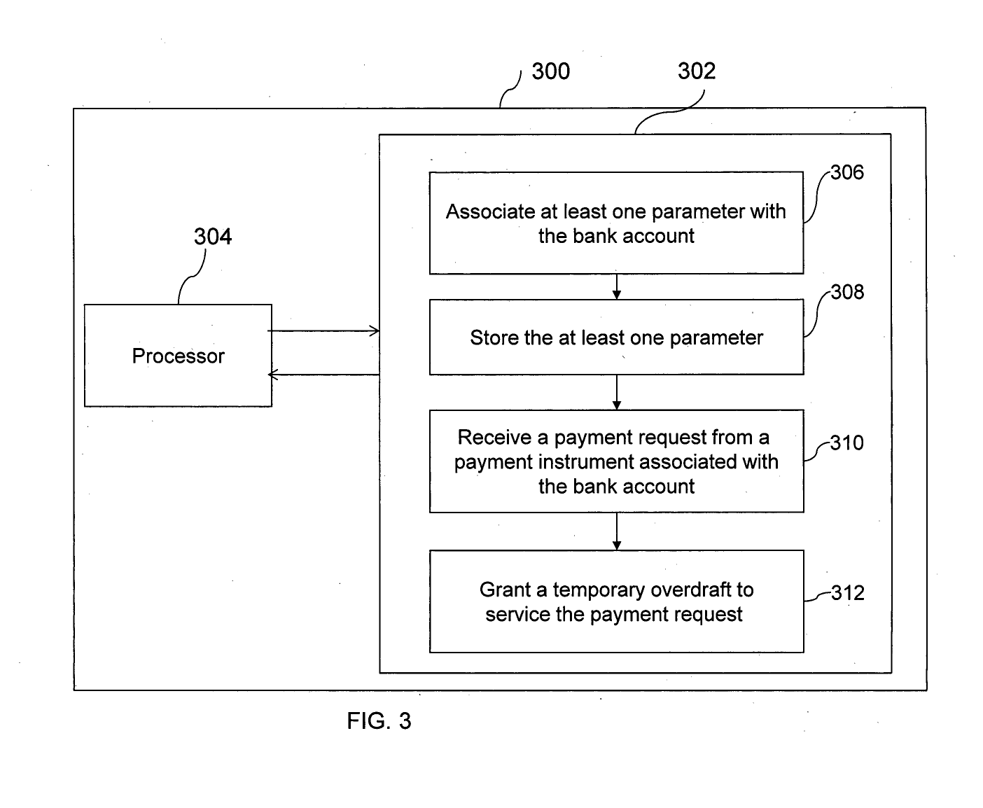

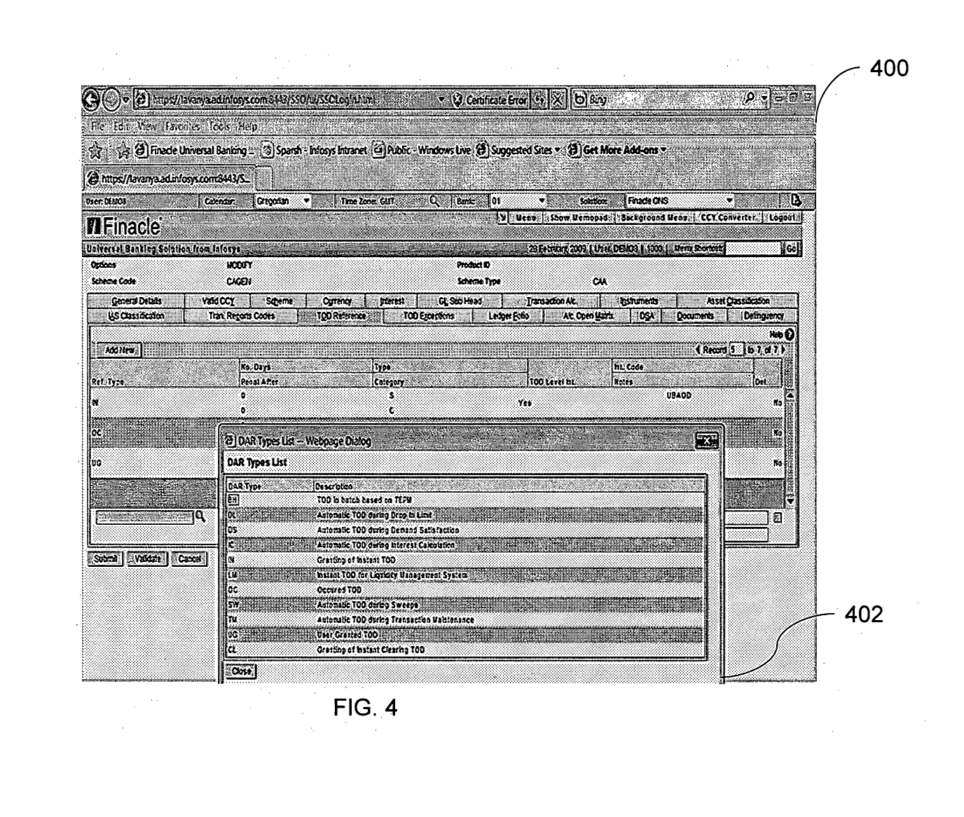

Referring specifically now to FIG. 2, a system for granting a temporary overdraft automatically, in accordance with an aspect of the present invention, is depicted. The system may comprise a computing environment 200 that includes a computer readable storage medium 202 in operable communication with a processor, 204. In the present aspect, the processor readable storage medium 202 may further contain a set of programming instructions. As additionally illustrated in FIG. 3, in the computing environment 300, the storage medium 302 in operable communication with the processor 304 contains at least the programming instructions operable for associating one or more parameters with a bank account, as in a block 306, and storing each of the parameters in the storage medium, as in a block 308. An example of parameter association and retrieval, as part of an implementation, is depicted in FIG. 4. The figure depicts a system 400, wherein a set of temporary parameters definable 402 are listed. Referring back now to FIG. 3, a payment request from a payment instrument associated with the bank account may be received, as in a block 310, and a temporary overdraft granted thereby, the overdraft linked to the bank account and the interest rate associated with the temporary overdraft determined on the basis of the previously stored parameters, as in a block 312.

An interaction between the computing environment and a payment instrument is also embodied in FIG. 2, wherein a payment request is sent to the computing environment by means of a payment instrument. Such a payment instrument may, for example, be a check, the check for withdrawing a sum of money from a customer's bank account. It may additionally be a withdrawal by means of an electronic debit card, by means of an electronic funds transfer, or by means of an automatic debit to service interest on a loan. In an additional embodiment, the temporary overdraft is granted only when a payment request associated with a particular type of payment instrument is received. In such an instance, a parameter specifying the type of payment instrument acceptable is associated with the account. When a payment request is received, the parameter is checked, and, a temporary overdraft authorized or rejected accordingly. Such a procedure aids in the directed grant of a temporary overdraft for a specific purpose.

In a further embodiment the payment request may be generated by a transaction initiated by an account holder. Additionally, the size of the temporary overdraft granted may be equal to an amount by which the payment request exceeds a sum of money deposited in the bank account, that is, a bank balance associated with the bank account.

An explanation of the purpose and function of parameters to determine or modify the grant of a temporary overdraft, in accordance with embodiments of the system and method described follows.

Overdraft accounts do not necessarily share the same characteristics as loan accounts, and may be limited in any of a variety of ways specified by the holding bank. To that end, the use of parameters to restrict overdraft activity on the basis of certain conditions, such as, for example, a type of payment request, enable a desirable level of flexibility for both the bank and the customer. A purpose of associating one or more parameters with the bank account, then, is to recognize a type of event occurring, and modify the grant of the temporary overdraft accordingly.

For example, as presently implemented, such a mechanism allows for controls on the date of grant of temporary overdrafts where a date desirable for temporary overdraft authorization is specified, and stored as a parameter. This is useful in an instance where a customer were to anticipate a debit on her account on a particular date, and was unsure of the capacity of her bank account to service an overdraft otherwise, or in an instance where an organization wants to ensure its ability to make payroll on a given day, and limit overdraft risk otherwise. The use of date limiting, then, would restrict temporary overdraft authorization on any day other than that specified, thereby mitigating the risk of an accidental and unwanted overdraft burden.

In another aspect of a present implementation, the monetary sum, or amount, by which the account may be overdrawn, is exactly equal to the monetary sum, or amount, by which the payment request exceeds the positive balance of the bank account.

Additional aspects include the imposition of a maximum credit limit on the bank account by associating the maximum credit limit as a parameter with the bank account, whereby the maximum size of the temporary overdraft extended may be deliberately limited by the bank. They also include the use of such parameters to track the frequency of grant of temporary overdrafts to a particular bank account. The bank may then choose to vary interest rates afforded a customer on that basis.

The determination of a maximum credit limit for a bank account by a bank may be based on certain factors, such as, for example, the present value of collateral linked to the bank account. Just as, traditionally, eligibility, size and interest rates for a type of loan are predicated on, for example, a customer's credit history and secured against her assets, so too may the bank desire to customize eligibility, size and interest rates for a temporary overdraft linked to the customer's bank account. To that end, a temporary overdraft may be secured against collateral, which may be in the form of securities, or other tangible or intangible assets that possess positive market value.

In an aspect of a preferred embodiment of the present invention, therefore, an indication as to whether a temporary overdraft is secured or unsecured may be stored as a parameter. Upon subsequent verification that the overdraft is secured, the availability of corresponding securities is checked, and the temporary overdraft may be granted accordingly.

However, in an instance where a temporary overdraft is secured against a volatile asset, such as, for example, stock, there may be a drop in an eligible maximum credit limit associated with the bank account were the value of the asset to deteriorate. Therefore, as per the bank's record, the particular amount by which an extant temporary overdraft that has been drawn on the account exceeds the now revised credit limit is to be reclassified as unsecured. Such a possibility is accounted for by monitoring the present value of linked collateral and the temporary overdraft and creating a parameter indicating an unsecured temporary overdraft, the temporary overdraft equal to the disparity between the depreciated collateral and the size of the previous, secured overdraft.

In a further aspect of the preferred embodiment of the invention, a differential interest rate between secured and unsecured temporary overdrafts may be charged by checking the value of the one or more parameters so associated with the bank account. If the result is that both secured and unsecured temporary overdrafts exist, then a higher interest rate may be imposed on the unsecured temporary overdraft. In this way, banks acquire the capability to manage the transition from secured to unsecured overdraft charges and adjust an associated interest rate accordingly and effectively segregate liability based on collateral values thereby.

As will be appreciated by those ordinary skilled in the art, the foregoing example, demonstrations, and method steps may be implemented by suitable code on a processor base system, such as a general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The preceding description was presented to enable a person of ordinary skill in the art to make and use the invention and is provided in the context of the requirement for a obtaining a patent. Said description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiments shown but is to be accorded the widest scope consistent with the principles and features described herein.

1. An account management computing device comprising:
a memory; and
a processor coupled to the memory and configured to execute programmed instructions stored in the memory, comprising:
associating at least one parameter with a bank account;
storing the at least one parameter associated with the bank account in the memory;
receiving a payment request from a payment instrument associated with the bank account, wherein the payment request exceeds a bank balance associated with the bank account; and
granting a temporary overdraft, wherein:
the temporary overdraft is linked to the bank account; and
an interest rate associated with the temporary overdraft is determined based on the at least one parameter associated with the bank account.

2. The device as claimed in claim 1, wherein the temporary overdraft is equal to an amount by which the payment request exceeds the bank balance associated with the bank account.

3. The device as claimed in claim 1, wherein the payment request is generated by a transaction initiated by an account holder.

4. The device as claimed in claim 1, wherein a temporary overdraft is exclusively granted when a payment request is received from a particular type of payment instrument associated with the bank account, and the particular type of payment instrument for which the temporary overdraft is exclusively granted is stored as a parameter associated with the bank account.

5. The device as claimed in claim 4, wherein the type of payment instrument comprises a check, an electronic debit card, an electronic funds transfer request or an interest payment request.

6. The device as claimed in claim 1, wherein the temporary overdraft has a maximum credit limit, the maximum credit limit for the temporary overdraft stored as a parameter associated with the bank account.

7. The device as claimed in claim 6, wherein the temporary overdraft is secured against the value of collateral associated with the bank account to create a secured temporary overdraft.

8. The device as claimed in claim 7, wherein the maximum credit limit associated with the secured temporary overdraft is linked to a present value of the collateral associated with the bank account, wherein the maximum credit limit associated with the temporary overdraft oscillates in correspondence with the present value of the collateral.

9. The device as claimed in claim 8, wherein the processor is further configured to execute programmed instructions stored in the memory comprising:
granting an unsecured temporary overdraft, the unsecured temporary overdraft linked to the bank account and granted when the payment request exceeds the maximum credit limit associated with a secured temporary overdraft linked to the bank account.

10. The device as claimed in claim 9, wherein an interest rate associated with the unsecured temporary overdraft is different from the interest rate associated with the secured temporary overdraft, the interest rate associated with the unsecured temporary overdraft stored as a parameter associated with the bank account.

11. The device as claimed in claim 1, wherein the bank account is allowed a temporary overdraft on a particular date, the temporary overdraft being blocked otherwise, and the particular date is stored as a parameter associated with the bank account.

12. The apparatus as claimed in claim 1, wherein a frequency of grant of a temporary overdraft to a particular bank account is stored as a parameter associated with the account.

13. A method for granting a temporary overdraft for a bank account automatically, the method comprising:
associating, by an account management computing device, at least one parameter with the bank account;
storing, by the account management computing device, the at least one parameter associated with the bank account;
receiving, by the account management computing device, a payment request from a payment instrument associated with the bank account, wherein the payment request exceeds a bank balance associated with the bank account;
retrieving, by the account management computing device, the at least one parameter;
determining, by the account management computing device, an interest rate for a temporary overdraft based the at least one parameter associated with the bank account; and
granting, by the account management computing device, the temporary overdraft for the bank account, wherein the temporary overdraft is linked to the bank account.

14. The method as claimed in claim 13, wherein the temporary overdraft is equal to an amount by which the payment request exceeds the bank balance associated with the bank account;

15. The method as claimed in claim 13, wherein a temporary overdraft is authorized exclusively when a payment request is received from a particular type of payment instrument associated with the bank account and the particular type of payment instrument for which the temporary overdraft is exclusively authorized is stored as a parameter associated with the bank account.

16. The method as claimed in claim 15, wherein the type of payment instrument comprises a check, an electronic debit card, an electronic funds transfer request or a loan interest debit request.

17. The method as claimed in claim 13, wherein the temporary overdraft has a maximum credit limit, the maximum credit limit for the temporary overdraft stored as a parameter associated with the bank account.

18. The method as claimed in claim 17, wherein the temporary overdraft is secured against the value of collateral associated with the bank account to create a secured temporary overdraft.

19. The method as claimed in claim 18, wherein the maximum credit limit associated with the secured temporary overdraft is linked to a present value of the collateral associated with the bank account, and wherein the maximum credit limit associated with the temporary overdraft oscillates in correspondence with the present value of the collateral.

20. The method as claimed in claim 19, wherein the method further comprises granting, by the account management computing device, an unsecured temporary overdraft, the unsecured temporary overdraft linked to the bank account and granted when the payment request exceeds the maximum credit limit associated with a secured temporary overdraft linked to the bank account.

21. The method as claimed in claim 20, wherein an interest rate associated with the unsecured temporary overdraft is different from the interest rate associated with the secured temporary overdraft, the interest rate associated with the unsecured temporary overdraft stored as a parameter associated with the bank account.

22. A non-transitory computer readable medium having stored thereon instructions for granting a temporary overdraft for a bank account automatically comprising machine executable code which when executed by a processor, causes the processor to perform steps comprising:
associating at least one parameter with the bank account;
storing the at least one parameter associated with the bank account;
receiving a payment request from a payment instrument associated with the bank account, wherein the payment request exceeds a bank balance associated with the bank account; and
granting a temporary overdraft, wherein:
the temporary overdraft is linked to the bank account; and
an interest rate associated with the temporary overdraft is determined based on the at least one parameter associated with the bank account.

23. The medium as claimed in claim 22, wherein the temporary overdraft is equal to an amount by which the payment request exceeds the bank balance associated with the bank account.

24. The medium as claimed in claim 22, wherein the payment request is generated by a transaction initiated by an account holder.

25. The medium as claimed in claim 22, wherein a temporary overdraft is exclusively granted when a payment request is received from a particular type of payment instrument associated with the bank account, and the particular type of payment instrument for which the temporary overdraft is exclusively granted is stored as a parameter associated with the bank account.

26. The medium as claimed in claim 25, wherein the type of payment instrument comprises a check, an electronic debit card, an electronic funds transfer request or an interest payment request.

27. The medium as claimed in claim 22, wherein the temporary overdraft has a maximum credit limit, the maximum credit limit for the temporary overdraft stored as a parameter associated with the bank account.

28. The medium as claimed in claim 27, wherein the temporary overdraft is secured against the value of collateral associated with the bank account to create a secured temporary overdraft.

29. The medium as claimed in claim 28, wherein the maximum credit limit associated with the secured temporary overdraft is linked to a present value of the collateral associated with the bank account, wherein the maximum credit limit associated with the temporary overdraft oscillates in correspondence with the present value of the collateral.

30. The medium as claimed in claim 29 further comprising [add boilerplate] granting an unsecured temporary overdraft, the unsecured temporary overdraft linked to the bank account and granted when the payment request exceeds the maximum credit limit associated with a secured temporary overdraft linked to the bank account.

31. The medium as claimed in claim 30, wherein an interest rate associated with the unsecured temporary overdraft is different from the interest rate associated with the secured temporary overdraft, the interest rate associated with the unsecured temporary overdraft stored as a parameter associated with the bank account.

32. The medium as claimed in claim 22, wherein the bank account is allowed a temporary overdraft on a particular date, the temporary overdraft being blocked otherwise, and the particular date is stored as a parameter associated with the bank account.

33. The medium as claimed in claim 22, wherein a frequency of grant of a temporary overdraft to a particular bank account is stored as a parameter associated with the account.
